(19) United States
(12) Patent Application Publication
(10) Pub. No.: US 2009/0266899 A1
(43) Pub. Date: Oct. 29, 2009

(54) CODE SCANNER

(75) Inventor: Naoto Yoshizawa, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/427,188

(22) Filed: Apr. 21, 2009

(30) Foreign Application Priority Data
Apr. 25, 2008 (JP) 2008-114876

(51) Int. Cl. G06K 7/10

(52) U.S. Cl. 235/472.01

(57) ABSTRACT

A flat housing has a first surface and a second surface in directions opposite to one another. The second surface has a scanning window. An area imaging element is located in an inner part of the scanning window. An attaching section attaches the housing to a human body of a user. The first surface and the front of the human body face each other. The user positions a code symbol in the front of the human body. A light source illuminates the code symbol. Light from the light source is reflected on the code symbol. The reflected light is received by an area imaging element. The area imaging element images the code symbol. A control unit decodes the code symbol imaged by the area imaging element. A transmitting unit transmits and outputs a result of the decoding of the code symbol.

### CROSS REFERENCE TO RELATED APPLICATION

This application is based upon and claims the benefit of priority from Japanese Patent Application No. 2008-114876, filed on Apr. 25, 2008, the content of which is incorporated herein by reference.

### TECHNICAL FIELD

The present invention relates to a code scanner used for scanning code symbols such as a barcode.

### BACKGROUND

A store such as a supermarket manages commodity sales and inventory. The store uses codes for the management. The store allocates the codes to respective commodities. A printer prints the commodity codes on stickers as code symbols (e.g., barcodes or two-dimensional codes). Store clerks stick the stickers to the respective commodities. The store clerks arrange the commodities on counters.

A customer passes a commodity on the counter to a store clerk in charge of checkout (a cashier). The cashier causes a code scanner to scan a code symbol of the commodity. The code scanner decodes the code symbol into a commodity code. The code scanner outputs the commodity code to an information processing apparatus (e.g., a standalone POS (Point Of Sales) or an ECR (Electric Cash Register)). The information processing apparatus uses the commodity code for processing for calculating a checkout amount, processing for storing information concerning sold commodities, and the like.

As the code scanner, there are a handy code scanner and a stationary code scanner (e.g., JP-A-11-353408). When the cashier uses the handy code scanner, the cashier holds the handy code scanner with one hand and holds a commodity with the other hand. The stationary code scanner is located on a checkout counter. When the cashier uses the stationary code scanner, the cashier stands right opposed to the stationary code scanner on the checkout counter, turns a code symbol of a commodity to the front of the stationary code scanner, and performs work for scanning the code symbol.

Before causing the code scanner to scan code symbols, the cashier searches for code symbols of commodities. When the cashier uses the handy code scanner, the cashier holds a commodity with the other hand, which does not hold the code scanner, and searches for a code symbol of the commodity while twisting the other hand. When the cashier searches for a code symbol, the commodity may slip off from the hand.

When the cashier uses the stationary code scanner, the cashier can surely hold a commodity with both the hands. Therefore, the cashier can quickly and safely find a code symbol attached to the commodity. However, the cashier has to turn the code symbol, which is once turned to the cashier, to a scanning unit of the code scanner again. The cashier has to hold the commodity over the scanning unit of the code scanner located right in front of the body of the cashier. In other words, work for scanning the code symbol using the stationary code scanner takes time.

### SUMMARY

It is an object of the present invention to cause a code scanner to quickly scan a code symbol attached to a commodity.

According to an aspect of the present invention, there is provided a code scanner including a housing that can be attached between the neck and the waist in the front of a human body and has a first surface and a second surface in directions opposite to each other, an attaching section for attaching the housing to a human body of a user in a state in which the first surface is opposed to the front of the human body, a scanning window formed in the second surface, an area imaging element that images a code symbol facing the scanning window, a transmitting unit that is housed in the inside of the housing and transmits data to the outside, and a control unit that is housed in the inside of the housing, decodes the code symbol imaged by the area imaging element, and causes the transmitting unit to transmit a result of the decoding.

According to another aspect of the present invention, there is provided a scanning method for a code symbol by a code scanner including a scanning window and an attaching section, the scanning method including turning one surface on which the scanning window of the code scanner is provided to a front direction of a user, attaching the other surface on the opposite side of the surface, on which the scanning window of the code scanner is provided, to a front side of a human body of the user with the attaching section, and positioning the code symbol in the front of the user and causing the code symbol to face the scanning window.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of an entire code scanner system;

FIG. 2A is an external perspective view of a front side (a second surface side) of a code scanner;

FIG. 2B is an external perspective view of a back side (a first surface side) of the code scanner;

FIG. 3A is an external perspective view of a back side (a first surface side) of another code scanner as a first modification;

FIG. 3B is a plan view of the other code scanner as the first modification;

FIG. 4 is a block diagram of an electric configuration of the code scanner system;

FIG. 5 is a diagram for explaining a procedure of a cashier scanning a code symbol attached to a commodity using the code scanner;

FIG. 6 is a perspective view of still another code scanner as a second modification viewed from a bottom surface side;

FIG. 7 is a schematic diagram of still another code scanner as a third modification attached to the cashier; and

FIG. 8 is a schematic diagram of still another code scanner as a fourth modification attached to the cashier.

### DETAILED DESCRIPTION

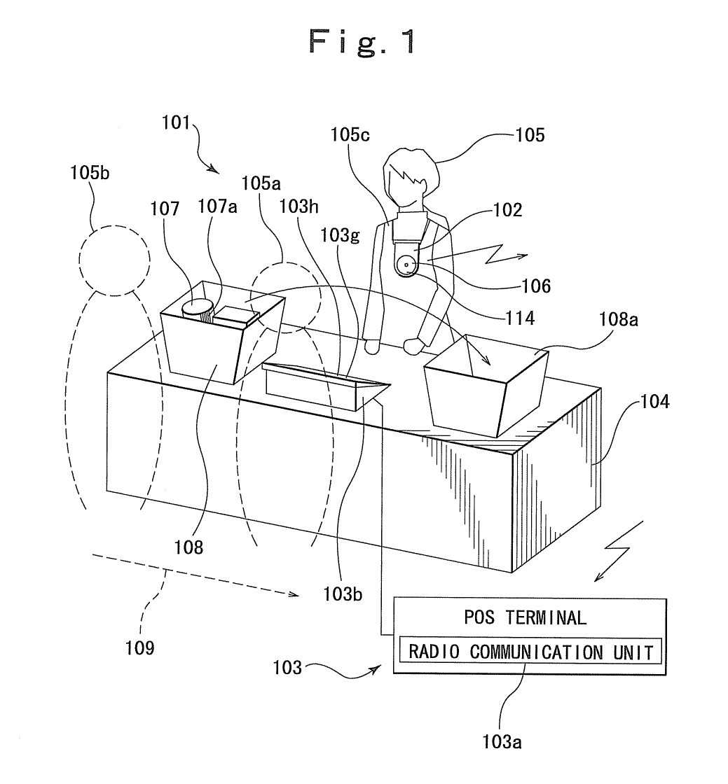

An embodiment is explained with reference to FIGS. 1 to 8.

FIG. 1 is a schematic diagram of an entire code scanner system 101. The code scanner system 101 includes a code scanner 102 and a standalone POS terminal 103.

A store displays various commodities 107 in a sales floor (not shown). The store allocates commodity codes to the commodities 107 in advance. The commodity codes specify the respective commodities. The commodity codes are attached to the surfaces of the commodities 107 in a form of code symbols 107a such as a barcode or a two-dimensional code. As an example, a barcode printer prints the code symbols 107a on stickers. Store clerks stick the stickers to the commodities 107.

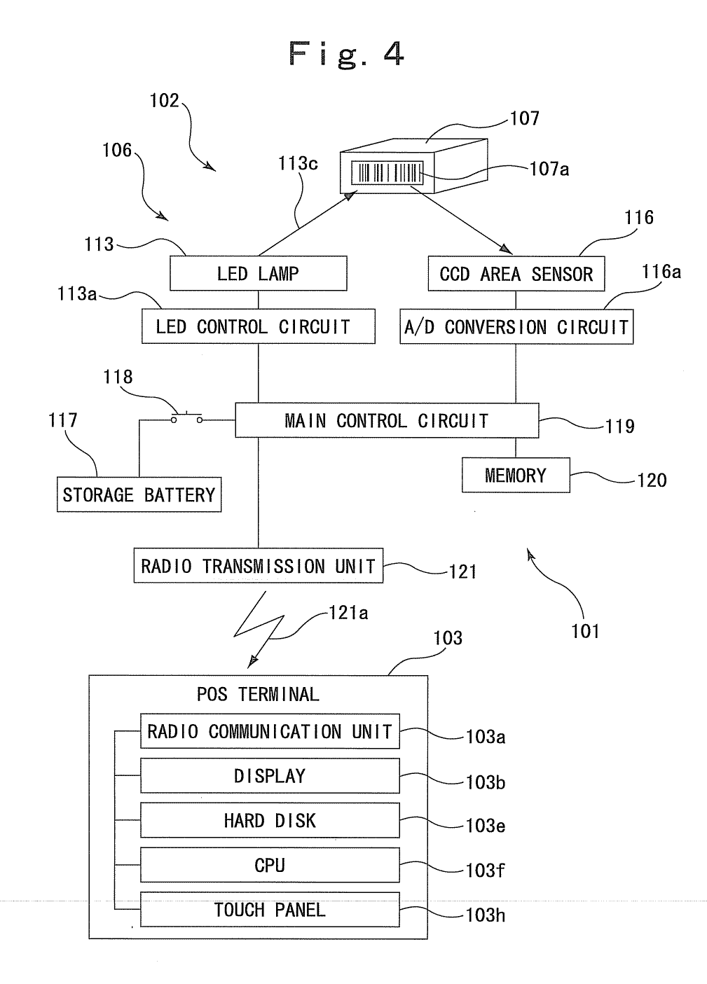

The code scanner 102 scans the code symbols 107a. The code scanner 102 makes use of a physical phenomenon concerning light. The code scanner 102 includes a CCD area sensor 116 (see FIG. 4) as an area imaging element. The code scanner 102 decodes the scanned code symbols 107a. The code scanner 102 transmits data obtained by the decoding to the outside by radio.

The store sets a checkout counter 104 at the edge of the sales floor. A store clerk in charge of checkout (a cashier 105) attaches the code scanner 102 in the front and the upper part of a human body (a body) of the store clerk. The cashier 105 waits near the checkout counter 104 in this state.

The POS terminal 103 includes a radio communication unit 103a as a receiving unit, a display 103b as a display unit, a hard disk 103e (see FIG. 4) as a storing unit, a CPU 103f (see FIG. 4), and a touch panel 103h as an operation input unit. The POS terminal 103 is located near or the inside of the checkout counter 104.

The radio communication unit 103a can receive data transmitted from the code scanner 102 by radio. The display 103b is located on a top surface of the checkout counter 104. The display 103b has a display screen 103g on which information is displayed. The cashier 105 faces the display screen 103g. The display 103b displays various kinds of information corresponding to processing in the POS terminal 103 on the display screen 103g. The touch panel 103h covers the display screen 103g.

The hard disk 103e stores a commodity data file, an operation system, and various driver programs and application programs (all of which are not shown in the figure). The commodity data file stores commodity information such as names and unit prices of respective commodities in association with commodity codes.

The CPU 103f of the POS terminal 103 determines whether the radio communication unit 103a receives a commodity code. When the CPU 103f determines that a commodity code is received, the CPU 103f acquires commodity information corresponding to the received commodity code from the commodity data file according to an application program.

Subsequently, the CPU 103f performs various kinds of processing using the acquired commodity information. One of the kinds of processing is processing for calculating a payment amount that a customer 105a should pay. Another one of the kinds of processing is processing for totalizing sales (amounts and numbers) by commodity code of the sold commodities 107. In the series of processing, the CPU 103f causes the display screen 103g of the display 103b to display various kinds of information such as the received commodity code, the acquired commodity information, and the calculated payment amount.

A flow of checkout work performed in the checkout counter 104 explained above is explained. The customer 105a puts the commodity 107 in a basket 108 and carries the commodity 107 to the checkout counter 104. The customer 105a lines up along a checkout line 109 and waits his or her turn. When his or her turn comes, the customer 105a places the carried basket 108 on the checkout counter 104.

The cashier 105 positions an empty basket 108a on a downstream side of the checkout counter 104 (a side farther from the sales floor) in advance. The cashier 105 takes out one commodity 107 from the basket 108. Subsequently, the cashier 105 brings the code symbol 107a attached to the commodity 107 closer to a scanning unit 106 of the code scanner 102. The scanning unit 106 of the code scanner 102 scans the code symbol 107a brought closer thereto. The cashier 105 puts the commodity 107, the scanning of the code symbol 107a of which is finished, in the empty basket 108a.

When scanning work for the code symbols 107a of all the commodities 107 stored in the basket 108 is finished, the cashier 105 touches the touch panel 103h and performs operation for declaring the end of code scanning. According to this operation, the POS terminal 103 decides a payment amount of the customer 105a. The display 103b displays the decided payment amount on the display screen 103g.

The cashier 105 informs the customer 105a of the payment amount displayed on the display screen 103g. The cashier 105 performs operation corresponding to payment by the customer 105a.

After settlement is finished, the customer 105a carries the basket 108a including the paid commodities 107 to a workbench (not shown). The customer 105a performs work for jamming the paid commodities 107 in a bag for bringing commodities back home.

The cashier 105 moves the basket 108 emptied after settlement is finished to a position where the empty basket 108a is placed and starts checkout work for the next customer 105b.

What is important is that, when the cashier 105 attaches the code scanner 102 according to this embodiment in the front of the human body (the body) of the cashier 105, a scanning area of the scanning unit 106 overlaps a code symbol check work area (between the arms in the front of the body) of the cashier 105.

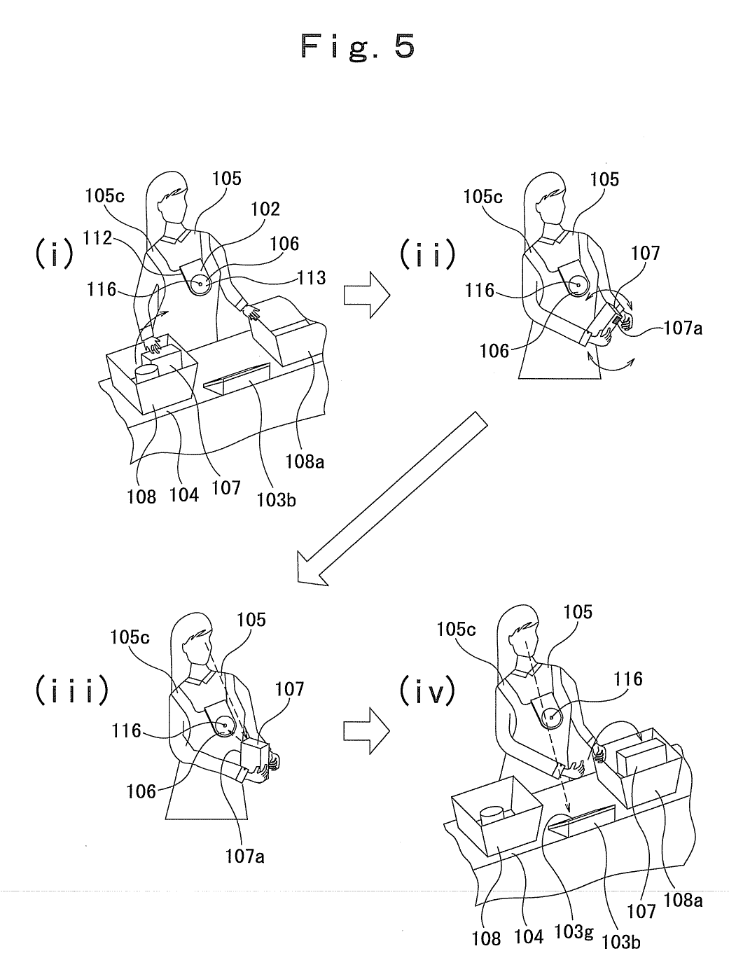

When the cashier 105 searches for the code symbol 107a of the commodity 107, the cashier 105 positions the commodity 107 in the front of the human body of the cashier 105 (between the arms in the front of the body). The code symbol 107a faces the scanning window 114. The scanning unit 106 of the code scanner 102 scans the code symbol 107a via the scanning window 114. Details of this point are explained with reference to FIGS. 4 and 5 later.

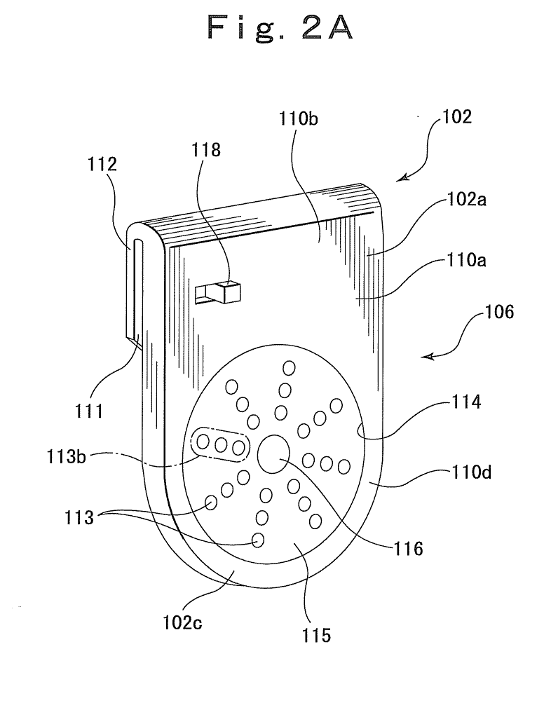

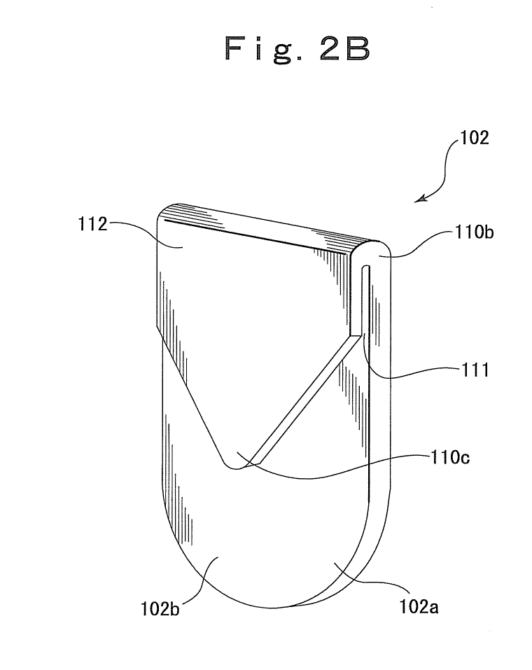

FIG. 2A is an external perspective view of a front side (a second surface 102c side) of the code scanner 102. FIG. 2B is an external perspective view of a back side (a first surface 102b side) of the code scanner 102. The code scanner 102 includes a main control circuit 119 (see FIG. 4) as a control unit, the scanning unit 106, a radio transmission unit 121 (see FIG. 4) as a transmitting unit, and a housing 102a.

The housing 102a is a flat small housing. The housing 102a houses the main control circuit 119, the scanning unit 106, and the radio transmission unit 121.

The cashier 105 attaches the code scanner 102 between the neck and the waist in the front of the human body of the cashier 105. The housing 102a has a shape and size that do not prevent free movement of both the arms of the cashier 105 in this state.

Desirable size of the code scanner 102 is about size of the palm of the human body. The code scanner 102 has size enough for covering the chest of the human body (a width dimension is equal to or smaller than a dimension between both the shoulder joints and a height dimension is equal to or smaller than a dimension between the collarbones and the bottom end of the ribs) at the maximum. The thickness of the code scanner 102 is desirably as small as possible.

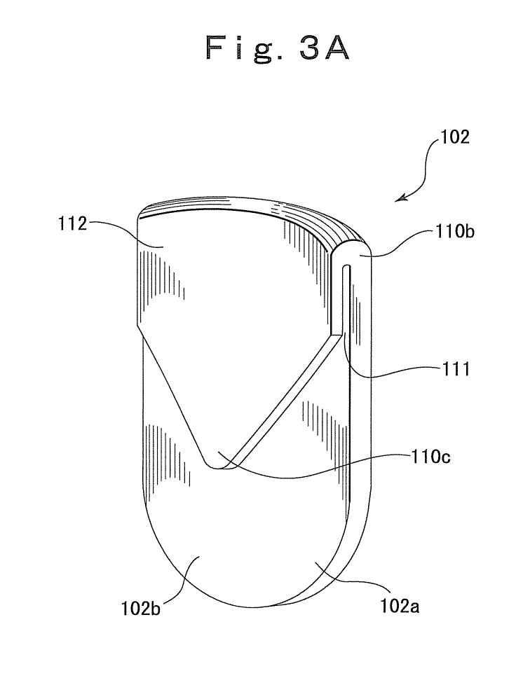

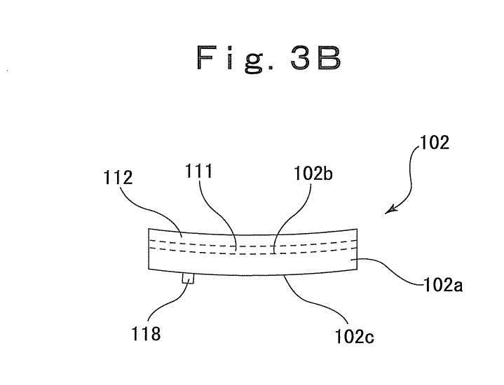

FIG. 3A is an external perspective view of the back side (the first surface 102b side) of another code scanner 102 as a first modification. FIG. 3B is a plan view of the other code scanner 102 as the first modification. The housing 102a of the code scanner 102 as the first modification is slightly rounded as a whole to the outer side (the front side (the second surface 102c side)). The inner side thereof (the back side (the first surface 102b side)) thereof is formed in a recessed curved surface shape. In this case, the back side (the first surface 102b side) of the housing 102a fits the front of the human body.

Returning to the explanation with reference to FIGS. 2A and 2B, the housing 102a has a shape with a small number of corner portions. Therefore, even if the cashier 105 touches the code scanner 102 with the arm or the like by mistake while the cashier 105 attaches the code scanner 102 in the front of the human body (the body) of the cashier 105, the cashier 105 is not hurt. A shape of the code scanner 102 is desirably a shape having circular roundness as shown in FIGS. 2A and 2B.

The housing 102a also houses a storage battery 117 (see FIG. 4). The weight of the entire code scanner 102 including the storage battery 117 is desirably as light as possible. As the code scanner 102 is lighter, the cashier 105 (the user) does not get tired even if the cashier 105 performs checkout work with the code scanner 102 attached to the body of the cashier 105.

The housing 102a is flat as a whole. The housing 102a has a generally rectangular flat section 110a. The flat section 110a has the first surface 102b and the second surface 102c on sides opposed to each other. A hook 112 is formed in an upper section 110b of the housing 102a.

The hook 112 is formed by being bent 180 degrees from the flat section 110a to the first surface 102b side. As shown in FIGS. 2A and 2B, an attaching space 111 is formed between the hook 112 and the flat section 110a. The hook 112 and the flat section 110a hold cloth.

The hook 112 attaches the code scanner 102 to the front of the human body of the cashier 105. The first surface 102b faces the front of the human body. The second surface 102c side of the flat section 110a faces a front direction same as the direction the front of the human body of the cashier 105 faces.

The hook 112 functions as an attaching section for attaching the code scanner 102 to the human body. As shown in FIG. 2B, the width of a distal end potion 110c of the hook 112 decreases toward the distal end. Therefore, the cashier 105 can easily suspend the code scanner 102 in the front of clothes 105c that the cashier 105 wears (see FIGS. 1 and 5).

The housing 102a has a scanning window 114 in a lower part 110d thereof. The scanning window 114 has a circular shape. As shown in FIGS. 2A and 2B, the scanning window 114 is formed on the second surface 102c to be depressed in a back surface direction. The lower part 110d of the housing 102a is formed in a semicircular shape to fit the shape of the scanning window 114. The scanning unit 106 is provided in the scanning window 114.

The scanning unit 106 faces a direction to the outer side in the scanning window 114. The scanning unit 106 includes plural LED lamps 113 as light sources and a CCD area sensor 116 as an area imaging element. The CCD area sensor 116 is located in a center position on a bottom surface of the scanning window 114.

The LED lamps 113 are located in directions in which the LED lamps 113 can emit light 113c (see FIG. 4) in a front direction on the bottom surface of the scanning window 114. More specifically, three LED lamps 113 form a lamp row 113b shown in FIG. 2A. Eight lamp rows 113b are arranged at equal intervals around the CCD area sensor 116. The number of LED lamps 113 is not limited to twenty-four (3·8 rows). As another example, the code scanner 102 may have a larger number of LED lamps 113 and illuminate the code symbol 107a brighter.

A transparent protective member 115 is fit in the scanning window 114. The protective member 115 covers the LED lamps 113 and the CCD area sensor 116. The protective member 115 protects the LED lamps 113 and the CCD area sensor 116.

The housing 102a houses the units such as the radio transmission unit 121 and the main control circuit 119 (for both the units, see FIG. 4). The housing 102a may conceal all the units excluding the scanning unit 106.

The housing 102a has a switch 118 on the second surface 102c. The switch 118 is a slide switch. The switch 118 switches ON and OFF of power feed to the units of the code scanner 102.

FIG. 4 is a block diagram of an electric configuration of the code scanner system 101 including the code scanner 102 and the POS terminal 103. The code scanner 102 includes the storage battery 117. The storage battery 117 feeds power to the units. When the code scanner 102 is set in a charging stand (not shown), the charging stand charges the storage battery 117.

The code scanner 102 includes the main control circuit 119 as the control unit. The main control circuit 119 executes arithmetic processing and performs driving control for the units. The main control circuit 119 is connected to a memory 120. The memory 120 rewritably stores data. The main control circuit 119 uses the memory 120 as a work area.

The main control circuit 119 is connected to the switch 118, the radio transmission unit 121 as the transmitting unit, an LED control circuit 113a, and an analog-digital (A/D) conversion circuit 116a. The LED control circuit 113a controls the LED lamps 113. The A/D conversion circuit 116a converts a voltage change in the CCD area sensor 116 into a digital value and outputs the digital value. The LED lamps 113 and the CCD area sensor 116 configure the scanning unit 106. The LED control circuit 113a and the A/D conversion circuit 116a configure a part of the control unit.

When the switch 118 is turned on, the storage battery 117 feeds power to the units of the code scanner 102. When the main control circuit 119 receives the power, the main control circuit 119 controls the LED control circuit 113a. The LED control circuit 113a causes the LED lamps 113 to emit light.

The light 113c emitted from the LED lamps 113 is made incident on the code symbol 107a attached to the commodity 107. The light 113c is reflected on the code symbol 107a. After the reflection, the light 113c is made incident on the CCD area sensor 116.

The A/D conversion circuit 116a generates a digital signal based on voltage generated in the CCD area sensor 116. The A/D conversion circuit 116a inputs the digital signal to the main control circuit 119. The main control circuit 119 calculates a commodity code based on the input digital signal. The A/D conversion circuit 116a and the main control circuit 119 restore the code symbol 107a sensed by the CCD area sensor 116 into a commodity code.

The main control circuit 119 controls the radio communication unit 121. The radio communication unit 121 outputs the commodity code as a radio signal 121a.

The CPU 103f of the POS terminal 103 determines whether the radio communication unit 103a of the POS terminal 103 receives the radio signal 121a. When the CPU 103f determines that the radio communication unit 103a receives the radio signal 121a, the CPU 103f restores the radio signal 121a into the commodity code. The CPU 103f uses the restored commodity code for various kinds of processing in the POS terminal 103.

FIG. 5 is a diagram for explaining a procedure of the cashier 105 scanning the code symbol 107a attached to the commodity 107 using the code scanner 102. The cashier 105 suspends the code scanner 102 in the front of the clothes 105c using the hook 112 in a procedure indicated by (i) to (iv) in FIG. 5. As a result, the code scanner 102 is located in the front of the upper part of the human body of the cashier 105.

The clothes 105c of the cashier 105 are located in the attaching space 111 (see FIGS. 2A and 2B). The hook 112 and the flat section 110a hold the clothes 105c. The scanning unit 106 of the code scanner 102 faces the front of the cashier 105.

The cashier 105 turns on the switch 118 (see FIG. 2A). The LED lamp 113 flashes. The cashier 105 takes out the commodity 107 planned to be purchased by the customer 105a from the basket 108 on the checkout counter 104 (FIG. 5 (i)).

Subsequently, the cashier 105 searches for the code symbol 107a attached to the commodity 107 (FIG. 5 (ii)). For this purpose, the cashier 105 turns the commodity 107 held in the hand and looks at all over the surface of the commodity 107. The commodity 107 is located in the front of the chest of the cashier 105.

During the search, the light 113c (see FIG. 4) from the LED lamp 113 is reflected on the surface of the commodity 107. The reflected light 113c is made incident on the CCD area sensor 116 of the scanning unit 106. The CCD area sensor 116 of the scanning unit 106 senses the surface of the commodity 107 that the cashier 105 holds and looks at (FIG. 5 (iii)).

The code scanner 102 decodes the sensed code symbol 107a. The code scanner 102 restores a commodity code from a result of the decoding. The code scanner 102 transmits the commodity code to the POS terminal 103 as the radio signal 121a (see FIG. 4).

The CPU 103f (see FIG. 4) of the POS terminal 103 determines whether the radio communication unit 103a (see FIGS. 1 and 4) of the POS terminal 103 receives the commodity code. When the CPU 103f determines that the radio communication unit 103a receives the commodity code, the CPU 103f uses the commodity code for, for example, processing for calculating a payment amount.

The CPU 103f causes the display screen 103g of the display 103b to display various kinds of information as a result of those kinds of processing. These kinds of information are the commodity code of the commodity 107 that the cashier 105 causes the code scanner 102 to scan, commodity information concerning the commodity 107, the calculated payment amount, and the like.

Subsequently, the cashier 105 looks at the information displayed on the display screen 103g of the display 103b. Consequently, the cashier 105 checks whether the commodity code is input to the POS terminal 103. After confirming the input of the commodity code, the cashier 105 puts the commodity 107, the scanning of the code symbol 107a of which is finished, in the basket 108a (FIG. 5 (iv)).

The cashier 105 performs, in the checkout work, the series of procedure explained with reference to FIG. 5 (i) to (iv) for all the commodities 107 in the basket 108.

In this procedure, an action of the cashier 105 for causing the CCD area sensor 116 to sense the code symbol 107a does not include an action for changing the direction of the commodity 107. As a result, in the checkout work, the cashier 105 can complete scanning operation for the commodity code with a small number of actions. This is different from a procedure performed by using the stationary code scanner.

The cashier 105 attaches the code scanner 102, holds and locates the commodity 107 in the front of the body of the cashier 105 and turns the commodity 107, and visually recognizes the code symbol 107a attached to the commodity 107. The code symbol 107a faces the scanning window 114 (see FIG. 2A). The CCD area sensor 116 senses the code symbol 107a. The code scanner 102 quickly scans the code symbol 107a.

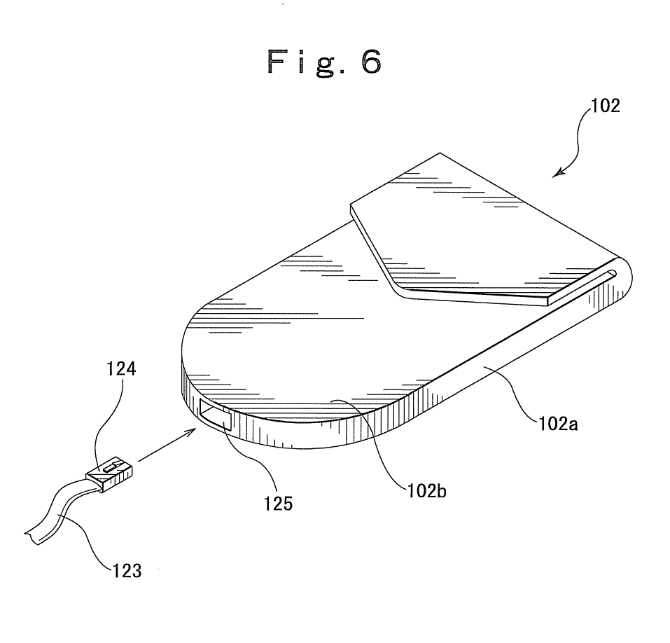

Another modification of the code scanner system 101 is explained with reference to FIG. 6. Components same as those shown in FIGS. 1 to 5 are denoted by the same reference numerals and signs and explanation of the components is omitted (the same applies in the following explanation).

Another code scanner 102 as a second modification shown in FIG. 6 includes a cord connecting unit 125 on a lower end surface of the housing 102a. A connector 124 of a connection cord 123 is inserted in the cord connecting unit 125. The code scanner 102 transmits a commodity code to the POS terminal 103 by wire via the connection cord 123.

The cord connecting unit 125 of the second modification is connected to an interface for wire communication provided in the code scanner 102. The interface for wire communication replaces the radio transmission interface 121 (see FIG. 4).

The connection cord 123 includes a feeder line. The connection cord 123 has connectors 124 at both ends. One of the connectors 124 is connected to the cord connecting unit 125 of the code scanner 102. The other is connected to a connecting unit of the interface for wire communication provided in the POS terminal 103. The interface for wire communication of the POS terminal 103 replaces the radio communication unit 103a (see FIG. 4).

When the connecting cord 123 connects the code scanner 102 and the POS terminal 103, the POS terminal 103 feeds power to the code scanner 102 via the feeder line 123a. The cord connecting unit 125, the connection cord 123, and the connector 124 may be those conforming to, for example, the USB (Universal Serial Bus) standard.

The code scanner 102 may or may not include the switch 118 for switching ON and OFF of the power feed. When the code scanner 102 does not include the switch 118, the POS terminal 103 may feed power to the code scanner 102 simultaneously when the connection cord 123 is connected to the code scanner 102.

The code scanner 102 in the second modification does not need to include a storage battery because power is fed from the POS terminal 103. Therefore, the weight of the code scanner 102 is reduced. The light code scanner 102 reduces physical burden on the cashier 105 who performs checkout work.

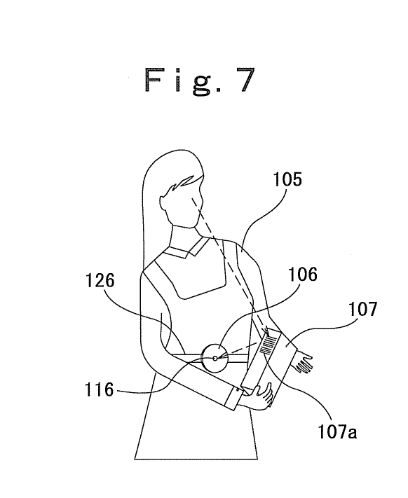

The housing 102a of still another code scanner 102 as a third modification shown in FIG. 7 includes a belt 126 as an attaching section. The cashier 105 wraps the belt 126 around the body (e.g. around the waist) to attach the code scanner 102 in the front of the body of the cashier 105. The belt 126 surely attaches the code scanner 102 in the front of the human body of the cashier.

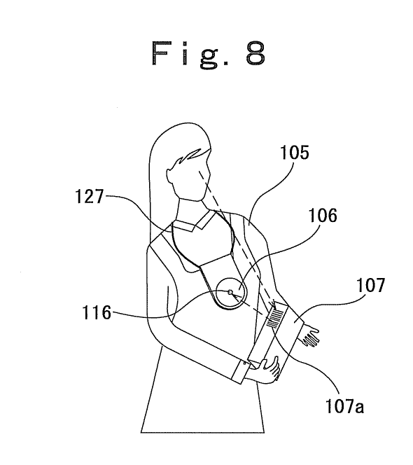

The housing 102a of still another code scanner 102 as a fourth modification shown in FIG. 8 includes a neckband 127 as an attaching section. The cashier 105 suspends the neckband 127 from the neck to attach the code scanner 102 in the front of the body of the cashier 105.

Obviously, numerous modifications and variations of the present invention are possible in light of the above teachings. It is therefore to be understood that within the scope of the appended claims, the invention may be practiced otherwise than as specifically described herein.

What is claimed is:

1. A code scanner comprising:
a housing that can be attached between a neck and a waist in a front of a human body and has a first surface and a second surface in directions opposite to each other;
an attaching section for attaching the housing to a human body of a user in a state in which the first surface is opposed to the front of the human body;
a scanning window formed in the second surface;
an area imaging element that is housed in an inside of the housing and images a code symbol facing the scanning window;
a transmitting unit that is housed in an inside of the housing and transmits data to an outside; and
a control unit that is housed in the inside of the housing, decodes the code symbol imaged by the area imaging element, and causes the transmitting unit to transmit a result of the decoding.

2. The code scanner of claim 1, wherein the first surface has a recessed curved surface shape.

3. The code scanner of claim 1, wherein the attaching section is a hook for suspending the housing from clothes of the user.

4. The code scanner of claim 2, wherein the attaching section is a hook for suspending the housing from clothes of the user.

5. The code scanner of claim 1, wherein the attaching section is a belt for wrapping the housing around the human body of the user.

6. The code scanner of claim 2, wherein the attaching section is a belt for wrapping the housing around the human body of the user.

7. The code scanner of claim 1, wherein the attaching section is a neckband for suspending the housing from a neck of the user.

8. The code scanner of claim 2, wherein the attaching section is a neckband for suspending the housing from a neck of the user.

9. A scanning method for a code symbol by a code scanner including a scanning window and an attaching section, the scanning method comprising:
turning one surface on which the scanning window of the code scanner is provided to a front direction of a user;
mounting the other surface on the opposite side of the surface, on which the scanning window of the code scanner is provided, on a front side of a human body of the user with the attaching section; and
positioning the code symbol in a front of the user and causing the code symbol to face the scanning window.

10. The method of claim 9, wherein
the other surface on the opposite side of the one surface is formed in a recessed curved surface shape, and the attaching is fitting the other surface on the front of the human body of the user.
